(19) United States
(12) Patent Application Publication
(10) Pub. No.: US 2009/0056760 A1
(43) Pub. Date: Mar. 5, 2009

(54) Metering Device

(75) Inventors: Arnd Kessler, Monheim (DE); Arno Dueffels, Duesseldorf (DE); Karl-Heinz Hohenadel, Langenfeld (DE)

Correspondence Address: Ratner Prestia, Suite 301, 1235 Westlakes Drive, Berwyn, PA, 19312, US

(73) Assignee: Henkel AG & Co. KGaA, Duesseldorf (DE)

(21) Appl. No.: 12/258,731

(22) Filed: Oct. 27, 2008

Related U.S. Application Data
(63) Continuation of application No. PCT/EP2007/052339, filed on Mar. 13, 2007.

(30) Foreign Application Priority Data
Apr. 25, 2006 (DE) 102006 019 603.1

(51) Int. Cl. B08B 7/04; B67D 5/06

(52) U.S. Cl. 134/18; 222/23

(57) ABSTRACT

A device having a reservoir that has an opening, a dosing chamber, and a movable conveying tool. The reservoir, the dosing chamber, and the conveying tool are disposed so the dosing chamber can be filled via the opening in the reservoir in a first position of the conveying tool. The opening of the reservoir is closed by means of the surface of the conveying tool in a second position of the conveying tool. The conveying tool can be moved from the first position into the second position via a thermo-sensitive switch that triggers the movement of the conveying tool. The disclosed device is suitable for metering pourable detergents, especially into the interior of washing or cleaning machines.

### CROSS REFERENCE TO RELATED APPLICATIONS

This application is a continuation under 35 U.S.C. §§ 120 and 365(c) of International Application PCT/EP2007/052339, filed on Mar. 13, 2007. This application also claims priority under 35 U.S.C. § 119 of DE 10 2006 019 603.1 filed on Apr. 25, 2006. The disclosures of PCT/EP2007/052339 and DE 10 2006 01 603.1 are incorporated by reference in their entirety.

### BACKGROUND OF THE INVENTION

The subject matter of the present application is a device for metering free-flowing detergents and cleaning agents as well as the use of such devices for metering free-flowing detergents and cleaning agents into the interior of a cleaning machine, preferably of a dishwasher.

Detergents and cleaning agents as well as processes for their manufacture are well known and consequently described widely in the prior art. Usually, they are made available to the consumer in the form of spray-dried or granulated powder products or in the form of liquid goods. In response to the consumer's desire for easier dosing, products in pre-dosed form have become established in the market place in addition to these two classical variants, and are likewise described comprehensively in the prior art, where, in particular, compressed moldings, i.e. tablets, blocks, briquettes and the like, and portions of solid or liquid detergents and cleaning agents packaged in pouches are to be mentioned.

This type of pre-portioning indeed facilitates the dosing of the corresponding detergent and cleaning agent, but does not relieve the consumer from the need to specifically dose the detergent and cleaning agent for each individual washing and cleaning step, this dosing generally including a series of steps that include beside the choice of the desired detergent and cleaning agent also the disposal of an outer packaging as well as placing the detergent and cleaning agent into the washing machine or dishwasher. In many cases the consumer is thus exposed to a direct contact with the detergent and cleaning agent.

Up to now, those devices that have been disclosed in the prior art for metering active substances, in particular detergent and active cleaning substances, often only permit a simple dosing of these substances.

Detergent containers that are solidly fastened on the washing machine drum are described in DE 39 34 123 (Henkel) and DE 39 22 342 (Fischer-Werke, Henkel). They are fastened by means of pins or snap-in hooks. The containers have to be removed from the washing machine after each wash and refilled.

In EP 0 215 366 is described a cleaning agent container having a fused closure, in which the fused closure melts at a defined working temperature thereby releasing the cleaning agent. In particular the closure of the container cannot be reused; in addition a multi dosing is not possible with this system.

DE 39 02 356 discloses a metering reservoir that likewise can only be used for one wash, and its working principle is likewise based on a temperature-dependent release of the cleaning agent. As a result of overpressure in the metering reservoir due to increasing temperature, a slide valve is moved into its open position and allows the cleaning agent to be discharged into the washing machine.

Although methods for multi dosing detergents and cleaning agents have likewise been described in the prior art, they are integrated in the machine and are therefore linked to a specific model of machine.

Thus the German Offenlegungsschrift DE 195 40 608 (Bosch-Siemens) discloses a device for the addition of cleaning agent in block form into dishwashers, said device permitting multi dosing, wherein the individual doses are controlled by a command from the dishwasher. The timing for the release of the dose is regulated by the dishwasher work program selected by the operator.

### DESCRIPTION OF THE INVENTION

Accordingly, the object of the present application is to provide a metering device for metering free-flowing detergent and cleaning agent, which enables the multi dosing of detergents and cleaning agents. This object is achieved by a device for the metering of free-flowing detergent and cleaning agent, which comprises a reservoir that is provided with an opening, a dosing chamber and a movable conveying tool.

Accordingly, a first subject matter of the present application is a device for the metering of free-flowing detergent and cleaning agent, which comprises
a) a reservoir that is provided with an opening,
b) a dosing chamber; and
c) a movable conveying tool,
wherein the reservoir, the dosing chamber, and the conveying tool are disposed such that in a first position of the conveying tool the dosing chamber can be filled through the opening in the reservoir while in a second position of the conveying tool the opening of the reservoir is closed by means of the surface of the conveying tool, and wherein the conveying tool can be moved from the first position into the second position, and the device further comprises a thermo-sensitive switch that triggers the movement of the conveying tool.

The reservoir of the device according to the invention is filled with a free-flowing detergent or cleaning agent. In addition to liquids, particulate detergents and cleaning agents are also designated as free-flowing detergents and cleaning agents. Therefore, the free-flowing detergents and cleaning agents also include, in addition to liquids, melts or gel(s), powders, granulates and extrudates. According to the invention, tablets and tableted premixes are not included in the term “free-flowing detergent and cleaning agent”.

In the present application, the term “liquid” designates substances or mixtures of substances just as solutions or suspensions, which are present in the liquid state.

The device according to the invention additionally comprises, besides the reservoir with an opening, a dosing chamber as well as a movable conveying tool. In the course of the metering process, the free-flowing detergent and cleaning agent is transported from the reservoir by means of the movable conveying tool through the opening of the reservoir into the dosing chamber and from the dosing chamber then reaches the surroundings, preferably directly into the interior of a cleaning machine or directly into the wash liquor present in the interior of the cleaning machine.

In a first preferred embodiment, the reservoir, the dosing chamber and the conveying tool form three individual and separate single parts of the device according to the invention. In this embodiment, the conveying tool possesses a conveying passage, through which the free-flowing detergent and cleaning agent can reach the dosing chamber from the reservoir.

In the first position (home position) at temperature T1, the reservoir, or the opening of the reservoir, and the dosing chamber are connected with one another by the conveying passage of the conveyor tool, and free-flowing detergent and cleaning agent can be conveyed from the reservoir into the dosing chamber. The free-flowing detergent and cleaning agent is preferably conveyed from the reservoir into the dosing chamber by the action of the force of gravity on the free-flowing detergent and cleaning agent. Consequently, the reservoir, when in use, is preferably located above the dosing chamber. In this first position, the dosing chamber is filled with free-flowing detergent and cleaning agent from the reservoir.

By changing the surrounding temperature, preferably by increasing the surrounding temperature to a temperature T2, a thermo-sensitive switch is actuated and triggers a movement of the conveying tool. This movement causes both the conveying tool and the conveying channel that connects the reservoir and the dosing chamber to move. The movement occurs in such a way that the connection between reservoir and dosing chamber is interrupted and consequently the free-flowing detergent and cleaning agent from the reservoir can no longer reach the dosing chamber. With the movement the conveying tool attains the second position (dosing position). In this position, the connection between reservoir and dosing chamber is interrupted, the opening of the reservoir being sealed by the surface of the conveying tool.

In consequence of the change in the surrounding temperature, the dosing chamber is also opened and in this way enables the free-flowing detergent and cleaning agent to discharge into the surroundings or enables the wash liquor to enter the dosing chamber. The dosing chamber can be directly or indirectly opened by actuating the thermo-sensitive switch. There is, however, the possibility of the dosing chamber possessing its own independent, preferably thermo-sensitive switch that when actuated, for example by increasing temperature, opens the dosing chamber.

A renewed change in the surrounding temperature, preferably a decrease in the surrounding temperature, reactuates the thermo-sensitive switches, now causing a second movement opposite to the first movement, thereby returning the conveyor tool to the first position (home position) and sealing the dosing chamber.

In the previously described embodiment, the conveying tool is movable, whereas the reservoir and the dosing chamber are immovable. The material exchange between reservoir and dosing chamber is ensured by the movable conveying tool that can move linearly or with a circular motion. In regard to reliability and incidence to faults, such devices according to the invention in which the conveying tool possesses a rotational axis about which it rotates on moving from the first position (home position) into the second position have proven to be advantageous.

In a further, particularly preferred embodiment, the dosing chamber is integrated into the movable conveying tool. In such an embodiment, the conveying passage of the conveying tool and the dosing chamber are basically identical. Devices according to the invention for the metering of free-flowing detergent and cleaning agent, wherein the dosing chamber is integrated into the movable conveying tool, are preferred according to the invention.

In the first position (home position) at temperature T1, the reservoir, or the opening of the reservoir, and the dosing chamber are connected with one another and free-flowing detergent and cleaning agent can be conveyed from the reservoir into the dosing chamber. In this embodiment too, the free-flowing detergent and cleaning agent is preferably conveyed from the reservoir into the dosing chamber by the action of the force of gravity on the free-flowing detergent and cleaning agent. Consequently, the reservoir, when in use, is also preferably located above the dosing chamber. In this first position, the dosing chamber is filled with free-flowing detergent and cleaning agent from the reservoir.

By changing the surrounding temperature, preferably by increasing the surrounding temperature to a temperature T2, a thermo-sensitive switch is actuated that triggers a movement of the conveying tool. This movement causes both the conveying tool and also the dosing chamber integrated in the conveying tool to move. The movement occurs in such a way that the connection between reservoir and dosing chamber is interrupted and consequently the free-flowing detergent and cleaning agent from the reservoir can no longer reach the dosing chamber. With the movement, the conveying tool attains the second position (dosing position). In this position the connection between reservoir and dosing chamber is interrupted, the opening of the reservoir is sealed by the surface of the conveying tool and the dosing chamber is opened in such a way to the surroundings so as to enable the free-flowing detergent and cleaning agent to discharge into the surroundings or the wash liquor to enter the dosing chamber.

A renewed change in the surrounding temperature, preferably a decrease in the surrounding temperature, reactuates the thermo-sensitive switch(es), now causing a second movement opposite to the first movement, thereby returning the conveyor tool to the first position (home position) and reconnecting the dosing chamber with the reservoir.

In this second preferred embodiment, the conveying tool and the dosing chamber that is integrated into the conveying tool are movable, whereas the reservoir alone is not movable. In this embodiment too, the movement of the conveying tool can be basically linear or with a circular motion, wherein in regard to its reliability and incidence to faults, such devices according to the invention are preferred, in which the conveying tool possesses a rotational axis about which it rotates on moving from the first position (home position) into the second position.

In a particularly preferred embodiment, in which the dosing chamber is integrated into a rotating conveying tool, the conveying tool has a density that is at least 0.1 g/cm³, preferably at least 0.2 g/cm³ and particularly at least 0.4 g/cm³ below the density of the detergent and cleaning agent to be dosed. When a conveying tool of this type with a filled dosing chamber is set in rotation by the actuation of the thermo-sensitive switch, then this rotational movement is intensified due to the difference in density between conveying tool and filled dosing chamber.

Independently of the structural design of the conveying tool, the movement of the conveying tool from the first position, in which the dosing chamber can be filled by the influx of free-flowing detergent and cleaning agent from the reservoir, into the second position, in which the opening of the reservoir is sealed by the surface of the conveying tool and thereby free-flowing detergent and cleaning agent cannot enter the dosing chamber, is triggered according to the invention by the actuation of a thermo-sensitive switch.

The thermo-sensitive switch triggers the movement of the conveying tool from the first position, in which the dosing chamber can be filled by the influx of free-flowing detergent and cleaning agent from the reservoir, into the second position especially at temperatures above 35° C., preferably above 40° C. and particularly preferably at temperatures between 40° C. and 70° C., quite particularly preferably at temperatures between 45° C. and 65° C.

The number of metering steps during cleaning cycles can be defined as a function of the progression of temperatures during such a cleaning cycle by choosing the temperature above which the thermo-sensitive switch is actuated (actuation temperature). If in the course of the cleaning cycle the actuation temperature is exceeded only once, then the free-flowing detergent and cleaning agent will also be metered only once during this cleaning cycle. However, if in the course of the cleaning cycle the actuation temperature is exceeded twice, for example because a wash liquor between two heating periods cools down to a temperature below the actuation temperature due to the entry of fresh water, then the free-flowing detergent and cleaning agent will also be metered twice during this cleaning cycle, in so far as the cooling is sufficient to restore the conveying tool to the first position (home position).

In a preferred embodiment, the thermo-sensitive switch comprises a thermo-sensitive substance or a thermo-sensitive mixture of substances, which changes its shape and/or its volume with a change in the surrounding temperature. Preferred thermo-sensitive substances or thermo-sensitive mixtures of substances exhibit different outer shapes (shapes and/or volumes) at different temperatures and are converted by alternating heating and cooling as often as required into these different outer shapes.

In a preferred embodiment, the thermo-sensitive switch comprises, for example, a switching element that exists at room temperature (20° C.) in the form of an elongated wire which contracts into a spiral shape when the temperature is increased above 40° C. and recovers its original elongated form when the temperature is cooled down to below 40° C.

In a further preferred embodiment, the thermo-sensitive switch comprises a substance or a mixture of substances whose volume, based on its volume at room temperature (20° C.), increases by more than 1.2 times, preferably by more than 1.5 times and especially by more than 2 times upon an increase in temperature to more than 40° C., and however on cooling down to room temperature returns again to its original value.

Bimetals, waxes, thermo-sensitive polymers (e.g. shape memory polymers) or shape memory alloys are preferably employed as the thermo-sensitive substances or mixtures of substances.

Metal strips of two layers of different materials that are firmly bonded with one another or are interlocking materials are referred to as bimetals. The change in shape with change in temperature is typical due to the different coefficients of linear thermal expansion of the metals in question. These metals can be for example zinc and steel or brass and iron. Preferred bimetallic switches are characterized in that with an increase in temperature and on reaching an increased temperature T2 these switches are deformed, this deformation, however, being made reversible not simply by falling below the temperature T2 but only by falling below a temperature T3 that is above T1 but below T2. Also in an embodiment of this type, the thermo-sensitive switch remains in the actuated position on falling below the actuation temperature T2, such that an unwanted multi dosing of the free-flowing detergent and cleaning agent can be avoided in cleaning cycles in which fluctuations in the temperature profile occur.

The shape memory alloys are metallic alloys that due to the action of external stimuli, for example a change in temperature, are able to change their outer shape, wherein several 100 000 movement cycles can be realized without noticeable fatigue. The change in shape is based on the temperature dependent crystalline rearrangement of two different crystal structures of a material. There are the austenite high temperature phase and the martensite low temperature phase. Both phases can transform into one another by changes in temperature (two way effect).

Two types of shape recovery, the extrinsic two way effect and the intrinsic two way effect, can be distinguished for the two way effect.

The extrinsic two way effect is referred to as the shape recovery by cooling a component, which is forced by an externally acting (mechanical) force. This can be realized for example by a spring that is stretched during heating.

In the intrinsic two way effect, the alloys can “remember” two shapes—one at high and one at low temperature. In order that the component on cooling takes up its defined shape again, it has to be “trained” by means of thermo mechanical treatment cycles.

Exemplary suitable materials are NiTi (Nitinol), CuZn, CuZnAl, CuZnNi or FeNiAl.

Inventive devices for metering free-flowing detergents and cleaning agents wherein the switch includes a bimetal, a wax, a thermo-sensitive polymer or a shape memory alloy are preferred. In addition, switches are preferred that include a composite material of
a bimetal and a polymer, preferably a thermo-sensitive polymer;
a bimetal and a shape memory alloy; or
a shape memory alloy and a polymer, preferably a thermo-sensitive polymer.

In a preferred embodiment, the movement of the conveying tool from the first position into the second position is caused exclusively by the change in shape and/or the change in volume of the thermo-sensitive substance or thermo-sensitive mixture of substances. However, in addition, those inventive devices are also preferred in which the change in shape and/or the change in volume of the thermo-sensitive substance or thermo-sensitive mixture of substances only trigger a movement that then, for example, is boosted by the action of gravitational force or by the action of an electric motor.

The device according to the invention is particularly suitable for the multi dosing of free-flowing detergent and cleaning agent. In a suitable embodiment, the device consequently possesses a reservoir, whose volume is more than a multiple of the volume of the dosing chamber. Devices wherein the reservoir is at least 4 times, preferably at least 8 times, particularly preferably at least 12 times and especially at least 16 times the volume of the dosing chamber are particularly preferred. The fillable empty volume of the reservoir is advantageously between 100 ml and 1000 ml, preferably between 100 ml and 800 ml and especially between 100 ml and 600 ml. The fillable empty volume of the dosing chamber is advantageously between 10 and 50 ml, particularly preferably between 10 and 40 ml and especially between 10 and 30 ml.

In a preferred embodiment, the reservoirs of the devices according to the invention are refillable. Those devices according to the invention are particularly preferred in which the reservoir can be removed from the device and subsequently filled or exchanged for a new, filled reservoir.

In addition, preferred devices according to the invention are constructed in such a way that avoids the ingress of moisture into the dosing chamber, especially however into the reservoir. For example, for this purpose the openings of the reservoir and/or of the dosing chamber can be provided with preferably elastic sealing elements that help to seal the device against the surrounding atmosphere, especially in the area of the movable components.

In order to prevent the ingress of moisture into the inventive device, it is further preferred that the reservoir, the dosing chamber and the conveying tool are housed in a common moisture-impervious housing.

Inventive devices can be integral components of a cleaning machine or be subsequently incorporated into the cleaning machines, for example in the interior of the cleaning machine. Devices for subsequent fixation into the interior of a cleaning machine preferably possess a retaining bracket or a fixation device, with which the device can be fixed for example on the inside of the door, the side walls or the fixtures of the cleaning machine, especially of the dishwasher.

A further subject matter of the present application is the use of an inventive device for metering free-flowing detergents and cleaning agents into the interior of a cleaning machine, preferably of a dishwasher.

Other than where otherwise indicated, or where required to distinguish over the prior art, all numbers expressing quantities of ingredients herein are to be understood as modified in all instances by the term “about”. As used herein, the words “may” and “may be” are to be interpreted in an open-ended, non-restrictive manner. At minimum, “may” and “may be” are to be interpreted as definitively including, but not limited to, the composition, structure, or act recited.

As used herein, and in particular as used herein to define the elements of the claims that follow, the articles “a” and “an” are synonymous and used interchangeably with “at least one” or “one or more,” disclosing or encompassing both the singular and the plural, unless specifically defined herein otherwise. The conjunction “or” is used herein in both in the conjunctive and disjunctive sense, such that phrases or terms conjoined by “or” disclose or encompass each phrase or term alone as well as any combination so conjoined, unless specifically defined herein otherwise.

The description of a group or class of materials as suitable or preferred for a given purpose in connection with the invention implies that mixtures of any two or more of the members of the group or class are equally suitable or preferred. Description of constituents in chemical terms refers unless otherwise indicated, to the constituents at the time of addition to any combination specified in the description, and does not necessarily preclude chemical interactions among the constituents of a mixture once mixed. Steps in any method disclosed or claimed need not be performed in the order recited, except as otherwise specifically disclosed or claimed or as needed to render such methods operative.

Changes in form and substitution of equivalents are contemplated as circumstances may suggest or render expedient. Although specific terms have been employed herein, such terms are intended in a descriptive sense and not for purposes of limitation.

What is claimed:

1. A device for metering a free-flowing detergent or cleaning agent, comprising a reservoir and agent having an opening for holding a predetermined amount of the free-flowing substance, the reservoir having an opening, a dosing chamber, and a movable conveying tool, wherein the reservoir, the dosing chamber, and the conveying tool are configured such that in a first position of the conveying tool, the reservoir and the dosing chamber are in fluid connection through the opening in the reservoir to allow the dosing chamber to be filled through the opening in the reservoir with the free-flowing agent, and such that in a second position of the conveying tool a surface of the conveying tool seals the opening of the reservoir, and wherein a thermo-sensitive switch triggers movement of the conveying tool between its first and second positions.

2. The device of claim 1, wherein the dosing chamber is integrated into the movable conveying tool.

3. The device of claim 1, wherein the thermo-sensitive switch comprises a bimetal, a wax, a thermo-sensitive polymer, or a shape memory alloy.

4. The device of claim 1, wherein the reservoir, the dosing chamber, and the conveying tool are housed in a common moisture-impervious housing.

5. The device of claim 1, wherein the reservoir has a volume at least 4 times greater than the dosing chamber.

6. The device of claim 5, wherein the reservoir has a volume at least 8 times greater than the dosing chamber.

7. The device of claim 6, wherein the reservoir has a volume at least 12 times greater than the dosing chamber.

8. The device of claim 7, wherein the reservoir has a volume at least 16 times greater than the dosing chamber.

9. A method of cleaning or washing, comprising the steps of providing the device of claim 1, connecting the device to a washing or cleaning machine such that the dosing chamber is positioned to discharge its contents into the washing or cleaning machine, and operating the washing or cleaning machine such that the thermo-sensitive switch is activated to trigger the movement of the conveying tool and thereby discharge the contents of the dosing chamber into the washing or cleaning process.
